(19) United States
(12) Patent Application Publication
(10) Pub. No.: US 2009/0255860 A1
(43) Pub. Date: Oct. 15, 2009

(54) Greywater diversion and hair catcher assembly for baths that is comprised of the novel assembly of a hair catcher mesh cup, a two-port valve, a direct-drain waste-overflow assembly, and an indirect-drain waste-overflow assembly

(76) Inventor: Christopher Adam McLeod, Toronto (CA)

Correspondence Address: CHRISTOPHER ADAM MCLEOD, 28 IMPERIAL STREET, TORONTO, ON, M5P 1C2, CA

(21) Appl. No.: 12/102,291

(22) Filed: Apr. 14, 2008

(51) Int. Cl. B01D 35/00

(52) U.S. Cl. 210/130

(57) ABSTRACT

Greywater diversion of bathwater for reuse is fast becoming a global necessity; however, there is a need for a device that separates the diversion function from the utilization system for reasons including backflow situations and odor control. Further, said device must be able to be installed in typical bath installation; further, the fiber filtering function must be located in a readily accessible position within the assembly. This invention describes the novel combination of a strainer-mounted hair catcher mesh cup, a two-port full-port variable-aperture valve, an indirect waste overflow fitting, and a direct waste overflow fitting to comprise a greywater diversion assembly that allows for easy cleaning, emergency backflow of greywater to the primary sanitary drain system, and installation within the restricted space beneath a bath in a typical North American bathroom.

A greywater diversion and hair catcher assembly for baths that is comprised of the novel assembly of a hair catcher mesh cup, a two-port valve, a direct-drain waste-overflow assembly, and an indirect-drain waste-overflow assembly.

### PRIOR ART

| | | |
|---|---|---|
| 2915875 | October 1975 | Olson |
| 5147532 | September 1992 | Leek, Jr. |
| 5160606 | November 1992 | Morrissey et al. |
| 6328882 | December 2001 | Rosenblatt |
| 6969460 | November 2005 | Bertram |

### BACKGROUND OF THE INVENTION

Bath design across the world shares one characteristic, a variously shaped vessel for holding water and bather concurrently. Bath design differs in how water is put in; bath design differs again in how water is safely conducted from the vessel to a sewer or other water management system. Water egressing from the bath vessel is widely called “greywater”, implying that, although the water may contain mild impurities, it is a valuable resource that can be reused in applications as diverse as cooling and garden irrigation.

This invention concerns a plumbing fixture fitting for baths and other vessels that allows for the diversion of this greywater upon demand, safely. This requires the integration of four critical features, (i) a hair catcher to capture fibers from entering the drain fitting, (ii) an on-demand diversion function, (iii) a three-port entry-exit system comprised of one entry port from the vessel drain and two exit ports, one to the primary sanitary drainage system and one to the greywater utilization system and (iv) a backflow capacity such that if and when the greywater usage system fails partially or entirely, the excess greywater will flow back to the primary sewer.

Although many an American household eager to save water for economic and environmental reasons has incorporated some of these features in home-made greywater diversion schemes, these systems are prone to failure, flooding, and even cross-contamination risks. Further, although commercial greywater diverters do exist outside North American for post-trap applications, these devices are not suitable for pre-trap applications owing to the inability to install these devices between the bath and the floor or traps beneath the floor as well as other problems arising from their design in ignorance of North American standard plumbing fittings.

### BRIEF SUMMARY OF THE INVENTION

This invention combines standard plumbing fixture fittings with a hair catcher and a two-port valve to effect a safe means of diverting greywater from a bath. The hair catcher acts to keep fibers out of the drainage system and/or greywater utilization system. The two-port valve is comprised of a variable diversion device such as a hand-turned ball valve or remotely operated solenoid valve that allow for partial or entire diversion of the waste water. A full-port valve is recommended to avoid restriction of the inner diameter of the drainage assembly. The invention of this device comes in the novel combination of two standard waste overflow bath fittings with the hair catcher and the valve to effect the safe diversion of greywater. The first fitting is a direct waste overflow assembly, which allows water to egress directly and vertically down to a waste system pipe located beneath the bath drain waste hole, wherein the bath overflow acts both as a vent and as a flooding control system. The second fitting is an indirect waste overflow assembly, which incorporates an elbow to horizontally direct drain water away from the bath drain waste hole to a sanitary tee fitting distal from the bath drain hole and approximately vertically beneath the overflow waste elbow attached to the side of the bath. By interconnecting these various fittings, a new device is created which allows for the safe diversion of greywater. A further embodiment adds a bleed between the two traps attached to the dual exit ports of this assembly.

### BRIEF DESCRIPTION OF THE DRAWING

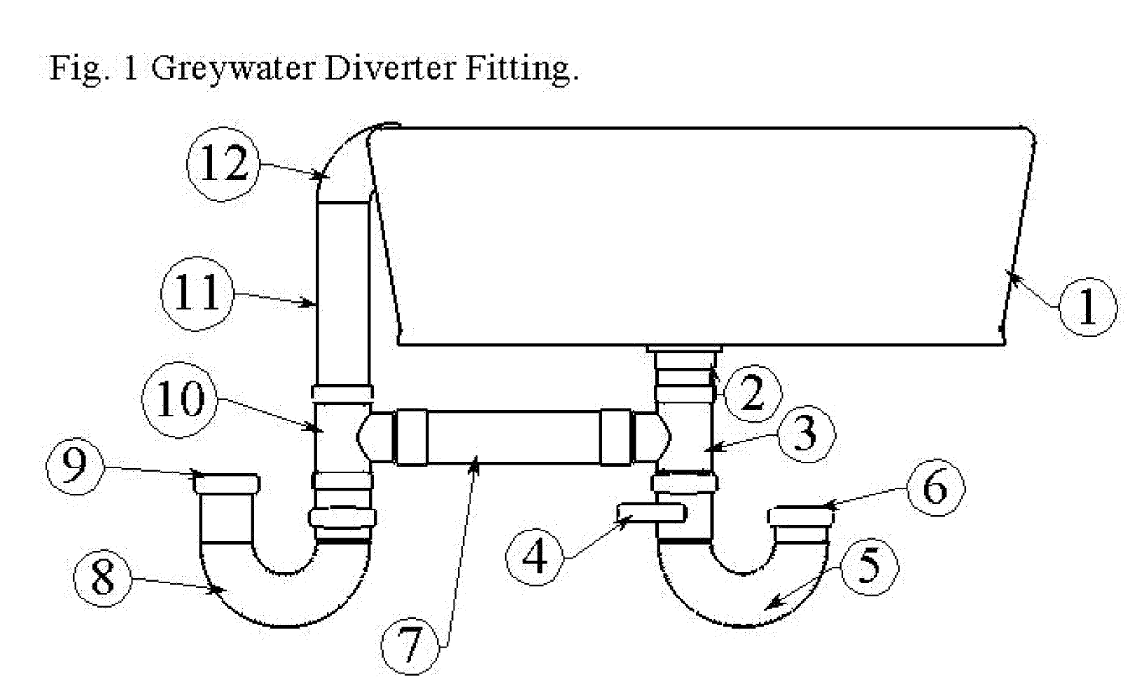

The invention is pictured in FIG. 1 attached to a standard bath (1). A direct drain tee fitting (3) is attached the bath by means of sealing rings and nuts, and contains a hair catcher wire mesh insert (2) that fits in the bath drain waste hole strainer component of the fitting. This wire mesh insert allows the closure of a plug without requiring removal of the wire mesh. A two-port valve (4) is operated to fully or partially prevent or allow the passage of greywater through a trap (5) eventually leading via port (6) to a greywater utilization system. Should this system be fully or partially unable to accept the full flow of the greywater draining from the bath, or if the user has adjusted the valve (4) to fully or partially block the egress of greywater from the bath, the drain water would then travel horizontally along the horizontal transverse connection pipe (7) to flow through a sanitary tee fitting (10). This fitting is also connected to a trap (8) and then leads via an exit port (9) to a primary sanitary drainage system. Note that the bath overflow (12) has two roles, the first as an air vent to enable the egress of drain water around either trap, and the second as an optional waste water drain (leading to the same chosen trap or traps) in the case of bath overflow where the waste drain has been blocked or stoppered with a plug.

### DETAILED DESCRIPTION

Olsen (U.S. Pat. No. 3,915,857) in 1975 started the greywater diversion patent stream with his highly complex tank and filter system. More than a diversion device, the patent describes a greywater utilization system, with various risks that would not be allowed in modern plumbing fixtures. In contrast, the invention described in this application makes no comment upon, and operates independently from, the greywater utilization system attached to the exit port of the diverter-side trap of the assembly. The invention in this application merely serves as a safe means of diverting greywater to that utilization system.

Similarly, Leek Jr. (U.S. Pat. No. 5,147,532) patented a device whereby greywater is fed to UV device for sterilizing greywater in a tank for direct re-use. The critical defining question for such systems is what occurs when there is too much greywater for the greywater usage system to manage. Although an overflow may be incorporated within a system such as Leek's, if the system fails, the overflow may fail too. It is preferable to separate out the safety overflow function upstream to the greywater utilization system in order to avoid backup of greywater to the bath fixture. A multiplicity of greywater utilization patents suffer from this basic flaw, including De Simone et al. (U.S. Pat. No. 5,160,606, 1992), Morrissey et al. (U.S. Pat. No. 5,403,498, 1995), and Rosenblatt (U.S. Pat. No. 6,328,882, 2001).

Bertram (U.S. Pat. No. 6,969,460) led the way out of this morass with his design of a valve that diverts greywater fully or partially away from the primary sanitary drain system, catches hair with a mesh insert, and finally allowing for backflow to the primary drain system should the greywater utilization system be fully or partially blocked. His device, however, is restricted in several aspects. These restrictions, and how they are addressed by the invention in this application, are described in the following paragraphs.

(i) Bertram's device cannot be physically attached to a typical North American bath. There is no space for a large vertical assembly between the bath and the floor, or again between the floor and the trap below the bath. The invention mentioned in this application requires only the cutting of an additional 1.5″ diameter hole in the floor beneath the bath, and the installation of an additional trap in the ceiling below the floor, both of which must be possible for virtually all given North American bath installations.

(ii) Bertram's device therefore must be located post-trap. The question of where this might be can be problematic. The device would have to be fixed to a wall very strongly to allow for regular cleaning of the hair catcher by opening and then forcing closed the sealed access cap. If this device is located outside, there is the further possibility of freezing or other damage.

(iii) Regular cleaning of the hair catcher is a difficult task in Bertram's device. Particularly if previous owners of a house had installed the greywater diverter as per Bertram's design, the new owners may be entirely oblivious to the necessity of regular cleaning, with the result that the new owners may think their greywater is being diverted to the greywater utilization system, but in fact it is backflowing down the primary sewer. In contrast, with the invention under application, the hair catcher is located in the bath drain hole. When the hair catcher needs cleaning, it is immediately obvious to the bath or shower user as drainage from the bath will be impeded. And it is much easier to clean since no access panel with pressure head requirements must be opened somewhere in the floor below.

(iv) If the greywater utilization system blocks up, this has the effect of trapping water from between Bertram's device and the trap supplying it (if the device is installed downstream of the trap) or between Bertram's device and the bath drain (if the device is installed upstream of the trap). This will give rise to odor as the water support bacterial growth. In contrast, the device in this application can be shut off completely with the two-way valve, allowing for the entire device to revert to an industry standard indirect waste overflow, avoiding odor problems associated with stagnation of pooled water.

For this and other reasons, although Bertram's device pointed the way to separating greywater diversion devices from the greywater utilization systems that supply it, its design contains a number of flaws that thwart its design intent. In contrast, the design in the application is based on a novel combination of traditional bath fittings, and avoids these problems.

Finally, there is the consideration that if a user were to keep their greywater diversion valve open constantly, the trap connecting the assembly to the primary sanitary drain may dry out and allow the ingress of sewer gases into the house. This potential risk is solved by interconnecting the two traps of this assembly by mean of any variety of connection tubes and fittings.

1) This invention combines a hair catcher, a 2 way valve, an indirect waste overflow bath fitting, and an indirect bath fitting to comprise a greywater diversion assembly that allows for the partial or entire diversion of bath greywater away from the primary sanitary drain within the restricted space beneath a bath.

2) If the greywater utilization system fails fully or partially, this invention allows for backflow of the greywater to the primary sanitary drain system without backflow into the bath.

3) Drying out of the assembly trap leading to the primary sanitary drain system upon extended and complete diversion of the bath greywater can be avoided by installing the two assembly traps at equivalent heights and interconnecting them to keep the water level constant in both water traps.
